(19) United States
(12) Patent Application Publication
(10) Pub. No.: US 2006/0199624 A1
(43) Pub. Date: Sep. 7, 2006

(54) Portable terminal device

(75) Inventors: Motonori Imamura, Kanagawa (JP); Hideto Takekawa, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/362,307

(22) Filed: Feb. 24, 2006

(30) Foreign Application Priority Data
Feb. 24, 2005 (JP) P.2005-048208

(51) Int. Cl. H04M 1/00

(52) U.S. Cl. 455/575.1; 455/550.1

(57) ABSTRACT

In a portable terminal device having a box casing including a pair of mutually opposed casing members and a board to be stored within the box casing, on one surface of the board, a first component group including a plurality of electronic components and a shield casing for covering these electronic components is provided. On the other surface of the board, a second component group including an electronic component and an electrical component is provided. In arranging the components selected from the first and/or second parts groups, when the key and/or one casing member is pressed, the pressing force thereof is supported by the other casing member through the selectively arranged components and the board.

This application claims foreign priority based on Japanese Patent application No. 2005-048208, filed Feb. 24, 2005, the content of which is incorporated herein by reference in its entirety.

### BACKGROUND OF THE INVENTION

1. Field of the Invention The present invention relates to a portable terminal device including a board, an electronic component and the like in a box casing.

2. Description of the Related Art

FIG. 11 is a side sectional view of an internal structure of a box casing 4 of a related folding-type portable terminal device 2 as referred to JP-A-2004-274466, the box casing 4 including an operation section such as ten keys. As shown in FIG. 11, the box casing 4 of the folding-type portable terminal device 2 includes a rigid circuit board 6 and a key sheet 8 which is made of silicon rubber inside thereof. The rigid circuit board 6 is fixed to the box casing 4 at two end portions thereof in longitudinal direction or at two end portions thereof in width direction.

On a first surface 6a of the rigid circuit board 6 on a side of the key sheet 8, a plurality of key switches 10 are provided. On a second surface 6b thereof that is situated on the opposite side to the first surface 6a, electronic components 12 and the like which are mounted thereon by soldering are disposed. On the key sheet 8, key tops 14 respectively corresponding to the key switches 10 are provided, and the key tops 14 are respectively exposed externally from key holes 16 formed in the box casing 4.

In the box casing 4 of the folding-type portable terminal device 2 having the above structure, when any one of the key tops 14 is pressed down with a finger of a user's hand or the like, the key switch 10 corresponding to this key top 14 is pressed down and, at the same time, the rigid circuit board 6 bents due to a load of the press-down.

Thus, since the rigid circuit board 6 is deformed repeatedly, the electronic component 12 may be broken and mounting portions thereof by soldering may be peeled off from the rigid circuit board 6. In order to prevent these inconveniences, the positions of the soldered portions of the electronic components are adjusted and arranged in the longitudinal direction and the width direction of the rigid circuit board 6 so that the positions of the soldered portions do not overlap on the positions of the key switches 10 in a thickness direction of the rigid circuit board 6.

Also, as shown in FIG. 12, as another related folding-type portable terminal device which is different from the folding-type portable terminal device 2 as referred to JP-A-2004-274466, there is known a folding-type portable telephone 20 in which the electronic components 12 and the like are mounted on both of the first surface 6a and second surface 6b of the rigid circuit board 6.

This folding-type portable telephone 20 includes a shield casing 22 for covering the electronic components 12 and the like mounted on the first surface 6a of the rigid circuit board 6, and a key FPC (Flexible Printed Circuit) 23 interposed between the shield casing 22 and key sheet 8. The key switches 10 are respectively disposed on the key FPC 23.

The shield casing 22 includes a ceiling plate 24 extending parallel to the rigid circuit board 6 and having a certain space between the rigid circuit board 6 and itself, and a sidewall 26 formed along an outer periphery of the ceiling plate 24 on a plane-shaped side so as to be perpendicular to the rigid circuit board 6. Also, the shield casing 22 includes ribs 28 respectively formed so as to be perpendicular to the rigid circuit board 6 in positions corresponding to intermediate positions of the rigid circuit board 6 in the longitudinal direction or in the width direction.

In the folding-type portable telephone 20 having the above structure, when any one of the key tops 14 is pressed down with a finger of a user's hand, the key switch 10 corresponding to this key top 14 is pressed down and, at the same time, a load of the press-down is transmitted through the ribs 28 of the shield casing 22 to the rigid circuit board 6 to thereby bend the rigid circuit board 6.

However, in the above folding-type portable telephone 20, although the electronic components 12 and the like can be disposed on both the first and second surfaces 6a and 6b of the rigid circuit board 6, when the number of the electronic components 12 and the like to be disposed per unit area on the rigid circuit board 6 increases, they are densely disposed. Therefore, it is difficult to prevent the breakage of the electronic components 12 and the like and prevent the peeling-off of the soldered portions by the method of adjusting the positions of the electronic components 12 and the like as referred in JP-A-2004-274466.

Also, in the folding-type portable telephone 20, when the electronic components 12 and the like are disposed densely on the rigid circuit board 6, a possible damage of the electronic components 12 and the like as well as the rigid circuit board 6 when impact loads or the like are applied from the outside due to a dropping down of the telephone 20 or the like needs to be prevented more positively than in the case of the related folding-type portable terminal device 2.

### SUMMARY OF THE INVENTION

An object of the invention is to provide a portable terminal device which can sufficiently prevent breakage of a circuit board as well as electronic components and the like due to a load of press-down when a key is pressed down and due to an impact load or the like applied from the outside.

In some implementations, a portable terminal device of the invention comprises: a first casing member; a second casing member facing the first casing member so as to form a box casing; a board being placed between the first casing member and the second casing member; a key component of which portions being exposed externally from key holes formed in the first casing member; a first electronic component mounted on one surface of the board, the one surface facing the first casing member; a shield member mounted on the one surface of the board so as to cover the first electronic component; and at least one of a second electronic component and an electrical component mounted on other surface of the board, the other surface facing the second casing member, wherein the shield member has at least one first supporting portion formed toward the one surface of the board at a position corresponding to an intermediate position of the one surface of the board, and the second casing member has at least one second supporting portion formed toward the other surface of the board at a position corresponding to an intermediate position of the other surface of the board.

### BRIEF DESCRIPTION OF THE DRAWINGS

FIG. 1 is a perspective view of a folding-type portable telephone 30, 100 according to a first embodiment and a second embodiment of the invention.

FIG. 2 is an exploded side view of an upper casing 46 and a lower casing 48 of a second box casing 36 shown in FIG. 1 as well as a rigid circuit board 54, a shield casing 56 (102), a key FPC 57 and a key sheet 59 respectively to be stored within the second box casing 36, showing a state before they are assembled together.

FIG. 3 is a plan view of the rigid circuit board 54, taken along the arrow lines A—A shown in FIG. 2.

FIG. 4 is a plan view of the shield casing 56 according to a first embodiment of the invention, taken along the arrow line B—B shown in FIG. 2.

FIG. 5 is a plan view of the lower casing 48, taken along the arrow line C—C shown in FIG. 2.

FIG. 6 is a sectional view of the second box casing 36, taken along the arrow lines D—D shown in FIG. 2, showing a state in which the upper casing 46 and lower casing 48 of the second box casing 36 shown in FIG. 2 as well as the rigid circuit board 54, shield casing 56, key FPC 57 and key sheet 59 respectively to be stored within the second box casing 36 are assembled together.

FIG. 7 is a sectional view of the second box casing 36, taken along the arrow lines E—E shown in FIG. 2, showing a state in which the upper casing 46 and lower casing 48 of the second box casing 36 shown in FIG. 2 as well as the rigid circuit board 54, shield casing 56, key FPC 57 and key sheet 59 respectively to be stored within the second box casing 36 are assembled together.

FIG. 8 is a plan view of the shield casing 102 of the folding-type portable telephone 100 according to a second embodiment of the invention, taken along the arrow line B—B shown in FIG. 2.

FIG. 9 is a sectional view of the second box casing 36, taken along the arrow lines D—D shown in FIG. 2, showing a state in which the upper casing 46 and lower casing 48 of the second box casing 36 of the folding-type portable telephone 100 according to a second embodiment as well as the rigid circuit board 54, shield casing 102, key FPC 57 and key sheet 59 respectively to be stored within the second box casing 36 are assembled together.

FIG. 10 is a sectional view of the second box casing 36, taken along the arrow lines E—E shown in FIG. 2, showing a state in which the upper casing 46 and lower casing 48 of the second box casing 36 of the folding-type portable telephone 100 according to the second embodiment as well as the rigid circuit board 54, shield casing 102, key FPC 57 and key sheet 59 respectively to be stored within the second box casing 36 are assembled together.

FIG. 11 is a side sectional view of a box casing 4 of a related folding-type portable terminal device 2 as well as a rigid circuit board 6 and a key sheet 8 respectively to be stored in the box casing 4 of the terminal 2.

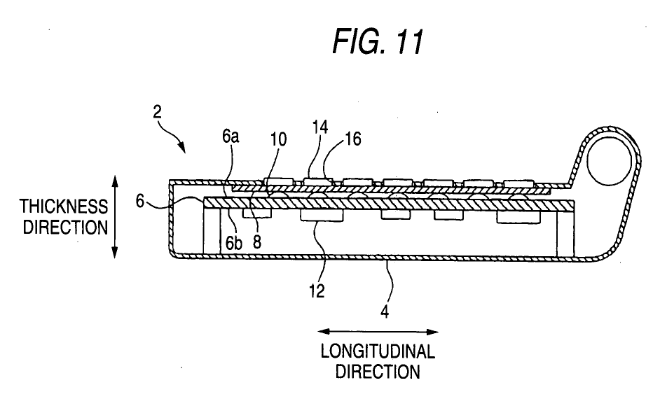

FIG. 12 is a side sectional view of a box casing 4 of another related folding-type portable telephone 20 as well as a rigid circuit board 6, a key sheet 8, a shield casing 22 and a key FPC 23 respectively to be stored in the box casing 4 of the telephone 20.

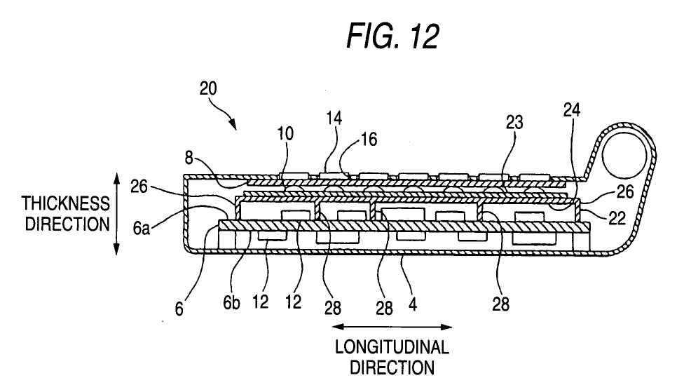

### DESCRIPTION OF THE PREFERRED EMBODIMENTS

Now, description will be certain below in detail of embodiments of a portable terminal device according to the invention with reference to the accompanying drawings.

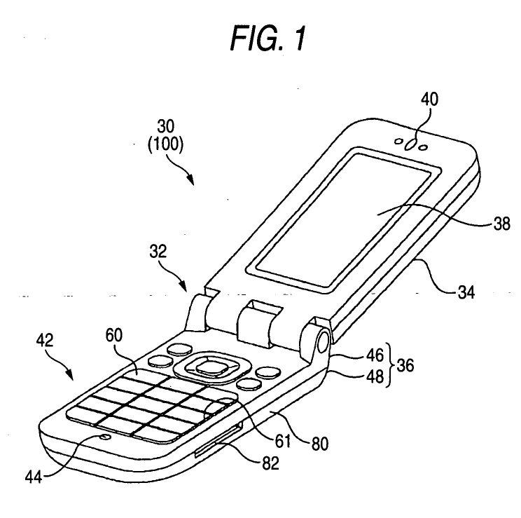

Here, FIGS. 1 to 7 are views which are used to explain a folding-type portable telephone 30 (a portable terminal device) according to a first embodiment of the invention.

As shown in FIG. 1, the folding-type portable telephone 30 according to the present embodiment includes a first box casing 34 and a second box casing 36 which are rotatably connected together through a hinge 32. The first box casing 34 includes a display 38 and a speaker 40. Also, the second box casing 36 includes an operation section 42 and a microphone 44, and the microphone 44 is disposed in a position near an end portion of the box casing 36 on an opposite side of the hinge 32 in the longitudinal direction of the second box casing 36.

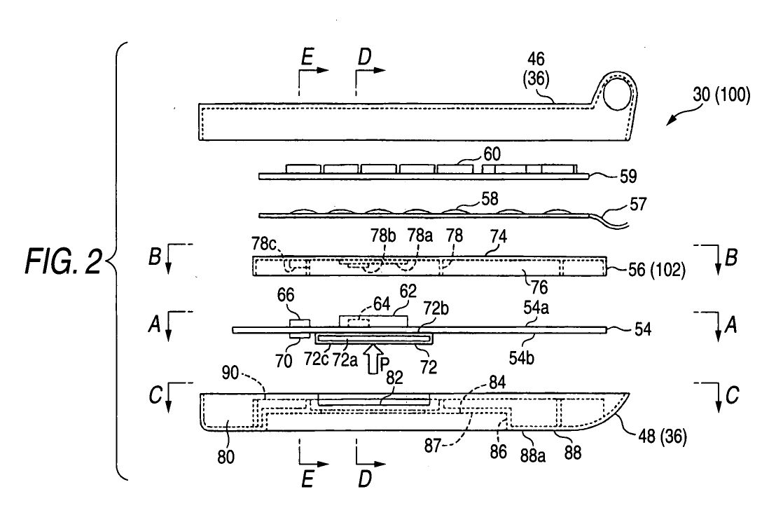

The second box casing 36 includes an upper casing 46 (a first casing member) having the operation section 42 and a lower casing 48 (a second casing member) which is arranged on the back side of the upper casing 46. As shown in FIG. 2, in an internal space formed between the upper and lower casings 46 and 48, a rigid circuit board 54, a shield casing 56, a key FPC (Flexible Printed Circuit Board) 57, and a key sheet 59 are sequentially placed from the lower casing 48 side.

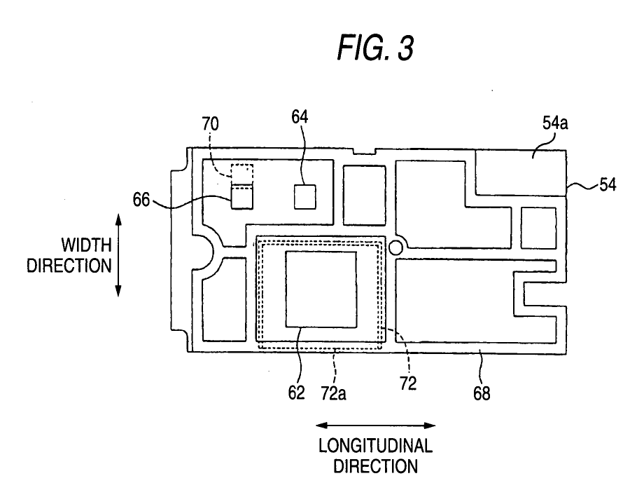

On a first surface 54a of the rigid circuit board 54 on the upper casing 46 side, as shown in FIGS. 2 and 3, a plurality of electronic components including semiconductor integrated circuits 62, 64 and 66 (IC chips) are disposed. Here, electronic components other than the semiconductor integrated circuits 62, 64 and 66 are not shown so as not to make the drawings complicated.

On the first surface 54a, as shown in FIG. 3, a reference potential pattern 68 which conducts a reference potential is formed. Actually, on the first surface 54a, besides the reference potential pattern 68, wiring patterns or the like which are used to supply electricity to a plurality of electronic components such as the electronic components 62, 64 and 66 are formed. However, wiring patterns other than the reference potential pattern 68 are not shown so as not to make the drawings complicated.

Also, as shown in FIG. 2, on the second surface 54b of the rigid circuit board 54 which is on the opposite side of the first surface 54a, a plurality of electronic components including a semiconductor integrated circuit 70 (IC chip), and a memory medium connector 72 (an electrical component) are arranged. The memory medium connector 72 is a device for, when a removable-type external memory medium such as an SD (Secure Digital) memory card (not shown) is inserted into its insertion opening 72a, performing a circuit connection to this removable-type external memory medium.

As shown in FIG. 3, the semiconductor integrated circuit 70 is arranged in a position which is the same in a longitudinal direction of the rigid circuit board 54 as the semiconductor integrated circuit 66 disposed on the first surface 54a side, and is arranged so as to overlap with the semiconductor integrated circuit 66 in a thickness direction of the rigid circuit board 54 in a certain length range in a width direction of the rigid circuit board 54.

Also, as shown in FIG. 2, the memory medium connector 72 is fixed so that a whole surface of a bottom plate 72b of the memory medium connector 72 contacts with the second surface 54b of the rigid circuit board 54. The memory medium connector 72 is disposed such that an area thereof on the first surface 54a side corresponding to the contact area thereof on the second surface 54b, as shown in FIG. 31, includes a contact area of the semiconductor integrated circuit 62 on the first surface 54a.

That is, the memory medium connector 72 is disposed in such position on the back side of the rigid circuit board 54 corresponding to the semiconductor integrated circuit 62, and the contact area between the memory medium connector 72 and rigid circuit board 54 is larger than the contact area between the semiconductor integrated circuit 62 and rigid circuit board 54.

Next, as shown in FIG. 2, the shield casing 56 is placed on the first surface 54a of the rigid circuit board 54. On the whole surface of the shield casing 56, a thin metal layer (a conductive member) is formed by an evaporation method or the like.

The shield casing 56 includes a ceiling plate 74 extending parallel to the rigid circuit board 54 and having a certain space between the rigid circuit board 54 and itself, and a side wall 76 formed along an outer periphery of the ceiling plate 74 on a plane-shaped side so as to be perpendicular to the rigid circuit board 54.

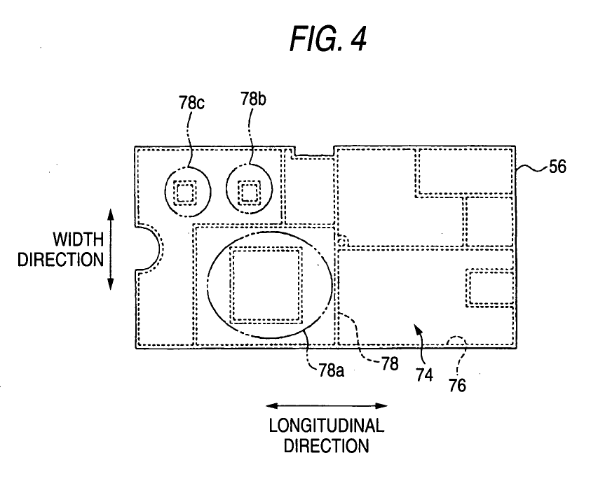

In the shield casing 56, as shown in FIG. 4, a rib 78 of a certain thickness which partitions a space enclosed by the ceiling plate 74 and the side wall 76 vertically and horizontally in parallel to the ceiling plate 74 is formed. The rib 78 has the same height as the side wall 76 in a direction perpendicular to the ceiling plate 74.

The side wall 76 and the rib 78 of the shield casing 56 are respectively formed so that portions thereof extending parallel to the ceiling plate 74 are in part formed along the shape of the reference potential pattern 68 of the rigid circuit board 54 as shown in FIG. 3. Therefore, the portions of the rib 78 in part contact with the reference potential pattern 68.

Also, portions of the rib 78 of the shield casing 56 as shown in FIG. 4, which extend parallel to the ceiling plate 74, other than the portions contacting with the reference potential pattern 68 of the rigid circuit board 54, that is, the portions respectively designated by reference numerals 78a, 78b and 78c in FIG. 4 are respectively formed so as to correspond to the edge portions on a plane-shaped side of the semiconductor integrated circuits 62, 64 and 66 as shown in FIG. 3.

The heights of these ribs 78a, 78b and 78c, as shown in FIG. 2, are respectively formed so as to correspond to the heights of the semiconductor integrated circuits 62, 64 and 66, and so that the ribs 78a, 78b and 78c contact with the upper surfaces of the edge portions of these circuits.

Next, the key FPC 57 is attached to the ceiling plate 74 of the shield casing 56. On the surface of the key FPC 57 on the opposite side of the shield casing 56, a plurality of key switches 58 are provided.

Also, on the key sheet 59, a plurality of key tops 60 which respectively correspond to the key switches 58 of the key FPC 57 are provided. Therefore, keys including the key switches 58 and the key tops 60 are disposed on the shield casing 56. The key tops 60, as shown in FIG. 1, are exposed to the outside from key holes 61 formed in the upper casing 46 of the second box casing 36.

Next, in the lower casing 48, in one side wall 80 extending parallel to the lower casing 48 in the longitudinal direction thereof, a cut-out portion 82 is formed through which a removable-type external memory medium such as an SD memory card (not shown) can be inserted into the memory medium connector 72. A position of the cut-out portion 82 in the longitudinal direction of the side wall 80 corresponds to a position of the memory medium connector 72 of the rigid circuit board 54 as shown in FIG. 2.

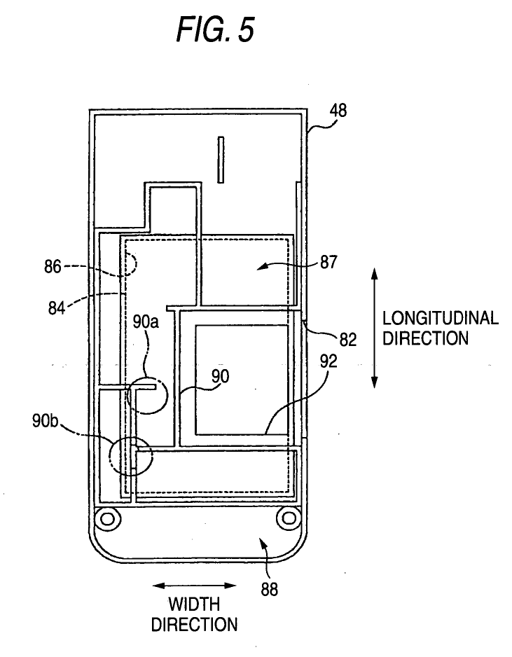

In the lower casing 48, as shown in FIGS. 2 and 5, a battery package storage section 86 is formed which is used to store a battery package 84 therein. The battery package storage section 86 is formed such that it includes, in a central portion on the plane-shaped side of the lower casing 48 as shown in FIG. 5, a storage bottom plate 87 having a certain depth in the thickness direction of the lower casing 48 from a bottom surface 88a of the bottom plate 88 which is on the opposite side of the upper casing 46 as shown in FIG. 2.

Also, on the lower casing 48, as shown in FIG. 5, a rib 90 (a supporting portion) of a certain thickness is formed which intersects a space existing in the interior of the lower casing 48 in a direction parallel to the bottom plate 88, preferably, intersects the space at right angles to thereby partition the space vertically and horizontally. The rib 90 is formed so as to have a height in a direction perpendicular to the bottom plate 88. In a state where the rigid circuit board 54 shown in FIG. 2 is stored within the second box casing 36, an end face of the rib 90 of the lower casing 48 in the height direction contacts with the second surface 54b of the rigid circuit board 54.

Portions of the rib 90 extending parallel to the bottom plate 88 are in part formed along the shapes of the side wall 76 and the rib 78 of the shield casing 56 shown in FIG. 4. That is, the portions of the rib 90 shown in FIG. 5 extending parallel to the bottom plate 88, as shown in FIG. 2, is in part formed to support portions of the second surface 54b of the rigid circuit board 54 that correspond to the side wall 76 and rib 78 of the shield casing 56.

Also, a portion of the rib 90 extending parallel to the bottom plate 88, which is designated by reference numeral 90a in FIG. 5, is formed so as to correspond to the position of the semiconductor integrated circuit 64 of the rigid circuit board 54 shown in FIG. 3. Thus, the rib 90a of the lower casing 48 shown in FIG. 5 faces a part of the rib 78b of the shield casing 56 shown in FIG. 4 in the thickness direction of the second box casing 36.

Also, a portion of the rib 90 designated by reference numeral 90b in FIG. 5 is formed so as to correspond to the position where the semiconductor integrated circuits 66 and 70 of the rigid circuit board 54 shown in FIG. 3 overlap in the thickness direction of the rigid circuit board 54. The rib portion 90b is lower in height by an amount corresponding to the thickness of the semiconductor integrated circuit 70. Thus, the rib 90b of the lower casing 48 shown in FIG. 5 faces a part of the rib 78c of the shield casing 56 shown in FIG. 4 in the thickness direction of the second box casing 36.

In the lower casing 48, as shown in FIG. 5, a rectangle hole 92 is formed which communicates with a space existing in the interior of the battery package storage section 86. This rectangle hole 92 corresponds to a position of the memory medium connector 72 shown in FIG. 3, and is also formed smaller than the memory medium connector 72 on the plane-shaped side.

Therefore, in a state where the rigid circuit board 54 is stored within the second box casing 36, as for the ceiling plate 72c of the memory medium connector 72 shown in FIG. 2, only the peripheral edge portion on the substantially rectangular plane-shaped side (not shown) (refer to FIG. 3) contacts with the storage bottom plate 87 of the battery package storage section 86 in the lower casing 48 shown in FIG. 5.

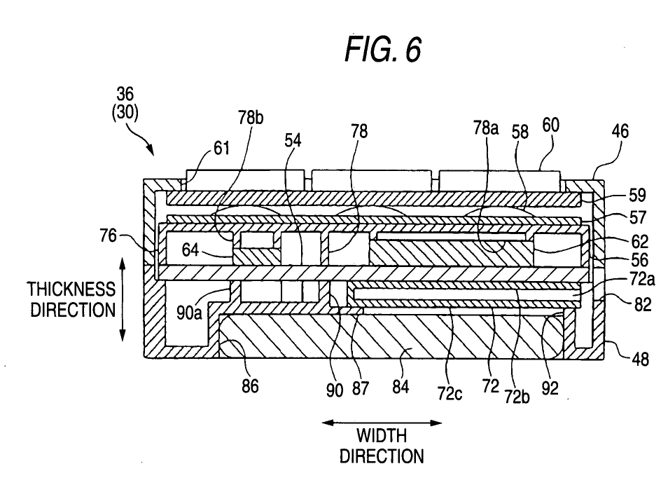

Now, FIG. 6 is a sectional view of the second box casing 36 along the arrow lines D—D shown in FIG. 2, showing an assembled state thereof. When any one of the key tops 60 shown in FIG. 6 is pressed down with a finger of a user's hand or the like, a load of the press-down (pressure load) is transmitted, for example, as a first route, through the rib 78 positioned substantially in the central portion in the width direction of the shield casing 56, the rigid circuit board 54 and the rib 90 of the lower casing 48 sequentially in this order.

Also, the press-down load of the key top 60 is also transmitted, as a second route, through the rib 78a of the shield casing 56, the semiconductor integrated circuit 62, the rigid circuit board 54, the memory medium connector 72, and the storage bottom plate 87 of the lower casing 48 sequentially in this order. Further, the pressing-down load of the key top 60 is also transmitted, as a third route, through the rib 78b of the shield casing 56, the semiconductor integrated circuit 64, the rigid circuit board 54, and the rib 90a of the lower casing 48 sequentially in this order.

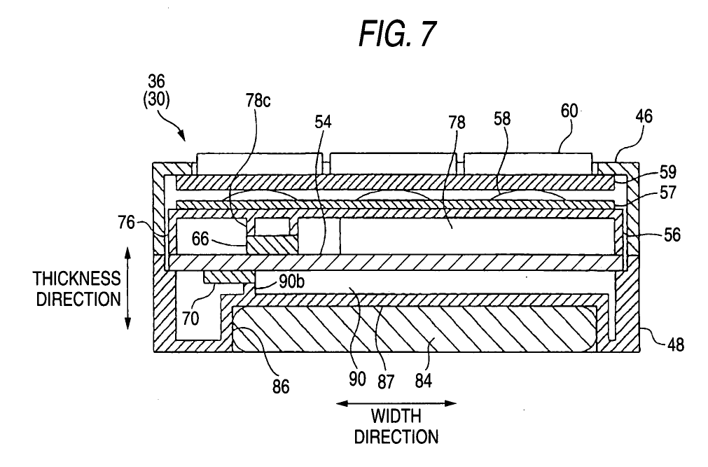

Next, FIG. 7 is a sectional view of the second box casing 36 along the arrow lines E—E shown in FIG. 2, showing its assembled state. When any one of the key tops 60 shown in FIG. 7 is pressed down with a finger of a user's hand or the like, the press-down load thereof is transmitted, similarly to the first route in FIG. 6, through the rib 78 of the shield casing 56, the rigid circuit board 54 and the rib 90 of the lower casing 48 (which are respectively shown in FIG. 7) sequentially in this order.

Also, the press-down load of the key top 60 is also transmitted, as a fourth route, as shown in FIG. 7, through the rib 78c of the shield casing 56, the semiconductor integrated circuit 66, the rigid circuit board 54, the semiconductor integrated circuit 70, and the rib 90b of the lower casing 48 sequentially in this order.

According to the folding-type portable telephone 30 of the present embodiment, the press-down load generated when the key is pressed down, the impact load applied from the outside or the like, which is transmitted to the intermediate position of the rigid circuit board 54 in the longitudinal direction or the width direction, is supported by the rib 90 formed in the lower casing 48, the storage bottom plate 87 of the battery package storage section 86 and the like. Thus, the deformation of the rigid circuit board 54 due to the pressure load when the key is pressed down, due to the impact load from the outside or the like is prevented. Therefore, even when the electronic components such as the semiconductor integrated circuits 62, 64, 66 and 70 as well as the memory medium connector 72 and the like are arranged densely on the rigid circuit board 54 stored within the second box casing 36, the circuit board, electronic components and the like can be sufficiently prevented from being broken due to the pressure load when the key is pressed down, the impact load applied from the outside or the like.

Also, the portions of the rib 90 of the lower casing 48 extending parallel to the bottom plate 88 of the lower casing 48, as shown in FIG. 5, are in part formed along the shapes of the side wall 76 and the rib 78 of the shield casing 56 shown in FIG. 4. Furthermore, the ribs 90a and 90b of the lower casing 48 shown in FIG. 5 respectively face a part of the ribs 78b and 78c of the shield casing 56 shown in FIG. 4 in the thickness direction of the second box casing 36. Therefore, as shown in FIGS. 6 and 7, the transmission route of the pressure load, the impact load or the like is linear, and thus does not generate a shearing force or a bending moment in the rigid circuit board 54, thereby being able to prevent the breakage of the circuit board, electronic components and the like.

Also, as shown in FIG. 2, since the memory medium connector 72 has a space between the bottom plate 72b and ceiling plate 72c, when a load P is applied to the center of the ceiling plate 72c, the memory medium connector 72 may be bent and deformed. However, as shown in FIGS. 5 and 6, since the rectangle hole 92 is formed, and the storage bottom plate 87 contacts with the ceiling plate 72c of the memory medium connector 72 in only the peripheral edge portion thereof, the memory medium connector 72 can be prevented from being deformed when the load is applied to the center of the ceiling plate 72c.

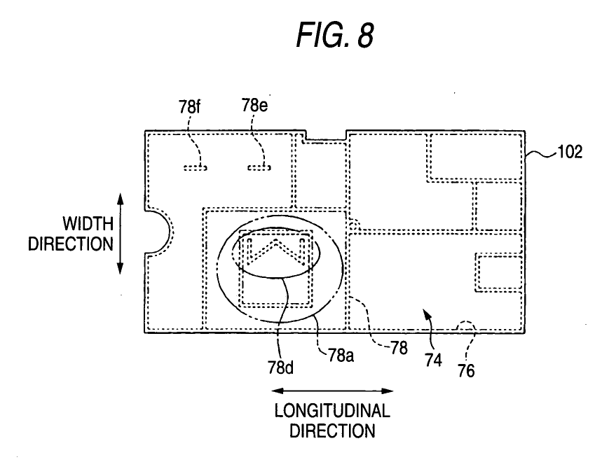

Next, a folding-type portable telephone 100 (a portable terminal device) according to a second embodiment of the invention is described with reference to FIGS. 8 to 10. In this embodiment, parts thereof same as those of the folding-type portable telephone 30 according to the above-mentioned first embodiment are given the same reference numerals in the following description, and thus the description of the similar structures is omitted.

In the folding-type portable telephone 100 according to the present embodiment, the shape of the rib 78 of the shield casing 102 thereof is slightly different from that of the rib 78 of the shield casing 56 according to the first embodiment as shown in FIG. 8.

That is, in a position inside the rib 78a and near to the central portion of the shield casing 102 in the width direction, an M-shaped rib 78d is formed. Also, instead of the ribs 78b and 78c of the shield casing 56 according to the first embodiment, ribs 78e and 78f are formed. These ribs 78e and 78f respectively correspond to parts of the rectangular-shaped ribs 78b and 78c of the shield casing 56 shown in FIG. 4. More particularly, the ribs 78e and 78f respectively correspond to the portions of one sides of the ribs 78b and 78c which extend parallel to the longitudinal direction of the shield casing 56 and are situated near the outside in the width direction of the shield casing 56.

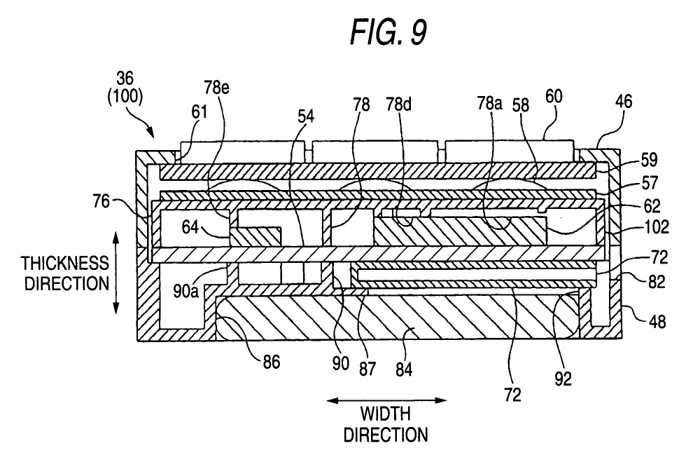

Now, FIG. 9 is a sectional view of the second box casing 36 along the arrow lines D—D shown in FIG. 2, showing its assembled state. When any one of the key tops 60 shown in FIG. 9 is pressed down with a finger of a user's hand or the like, the press-down load thereof, similarly to the above-mentioned first embodiment, is transmitted, for example, as a first route, through the rib 78 situated substantially in the central position of the shield casing 102 in the width direction, the rigid circuit board 54 and the rib 90 of the lower casing 48 sequentially in this order.

Also, the pressing-down load of the key top 60 is transmitted, as a second route, through the rib 78d of the shield casing 102, the semiconductor integrated circuit 62, the rigid circuit board 54, the memory medium connector 72 and the storage bottom plate 87 of the lower casing 48 sequentially in this order. Alternatively, the load may be transmitted also through the rib 78d situated inside the rib 78a of the shield casing 102.

Therefore, referring to the press-down load transmitted to the memory medium connector 72 disposed on the side opposite to the ribs 78a and 78d with the rigid circuit board 54 in-between, more amount of the load is transmitted to the portion of the memory medium connector 72, which is on the side opposite to the insertion opening 72a of the memory medium connector 72 in the width direction of the second box casing 36, compared to the portion of the memory medium connector 72 near the insertion opening 72a.

Also, in the shield casing 102, instead of the rib 78b formed in the shield casing 56 according to the first embodiment, the rib 78e is formed. Therefore, the press-down load of the key top 60 is transmitted, as a third route, through the rib 78e of the shield casing 102, the semiconductor integrated circuit 64, the rigid circuit board 54, and the rib 90a of the lower casing 48 sequentially in this order.

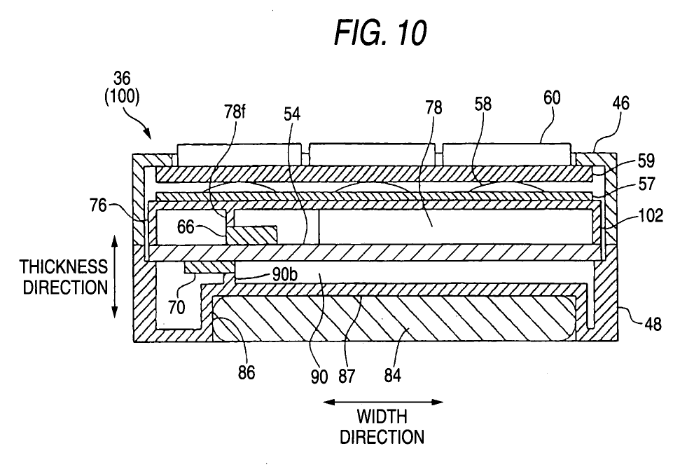

Next, FIG. 10 is a sectional view of the second box casing 36 along the arrow lines E—E shown in FIG. 2, showing its assembled state. Since, in the shield casing 102, the rib 78f is formed instead of the rib 78c of the shield casing 56 according to the first embodiment, the press-down load of the key top 60 is transmitted, as a fourth route, through the rib 78f of the shield casing 102, the semiconductor integrated circuit 66, the rigid circuit board 54, the semiconductor integrated circuit 70, and the rib 90b of the lower casing 48 sequentially in this order.

Thus, according to the folding-type portable telephone 100 of the present embodiment, similarly to the above-mentioned first embodiment, the press-down load generated when the key is pressed down, the impact load applied from the outside or the like, which is transmitted to the intermediate position of the rigid circuit board 54 in the longitudinal direction or the width direction, is supported by the rib 90 formed in the lower casing 48, the storage bottom plate 87 of the battery package storage section 86 and the like. Thus, the deformation of the rigid circuit board 54 due to the pressure load when the key is pressed down, due to the impact load from the outside or the like is prevented. Therefore, even when the electronic components such as the semiconductor integrated circuits 62, 64, 66 and 70 as well as the memory medium connector 72 and the like are arranged densely on the rigid circuit board 54 stored within the second box casing 36, the circuit board, electronic components and the like can be sufficiently prevented from being broken due to the pressure load when the key is pressed down, the impact load applied from the outside or the like.

Also, similarly to the first embodiment, the portions of the rib 90 of the lower casing 48 extending parallel to the bottom plate 88 of the lower casing 48, as shown in FIG. 5, are in part formed along the shapes of the side wall 76 and the rib 78 of the shield casing 56 shown in FIG. 4. Furthermore, the ribs 90a and 90b of the lower casing 48 shown in FIG. 5 respectively face a part of the ribs 78e and 78f of the shield casing 102 shown in FIG. 8 in the thickness direction of the second box casing 36. Therefore, as shown in FIGS. 9 and 10, the transmission route of the pressure load, the impact load or the like is linear, and thus does not generate a shearing force or a bending moment in the rigid circuit board 54, thereby being able to prevent the breakage of the circuit board, electronic components and the like.

Further, similarly to the first embodiment, as shown in FIG. 2, since the memory medium connector 72 has a space between the bottom plate 72b and ceiling plate 72c, when a load P is applied to the center of the ceiling plate 72c, the memory medium connector 72 may be bent and deformed. However, as shown in FIGS. 8 and 9, since the rectangle hole 92 is formed, and the storage bottom plate 87 contacts with the ceiling plate 72c of the memory medium connector 72 in only the peripheral edge portion thereof, the memory medium connector 72 can be prevented from being deformed when the load is applied to the center of-the ceiling plate 72c.

And, as shown in FIG. 9, since the rib 78d is formed in the shield casing 102, the press-down load of the key top 60 to be transmitted to the memory medium connector 72 becomes larger in amount, in the width direction of the second body 36, in the opposite portion of the memory medium connector 72 to the insertion opening 72a than in the portion of the memory connector 72 near to the insertion opening 72a which is weak in structure. Therefore, the memory medium connector 72 can be prevented more positively against deformation than in the first embodiment.

Also, as shown in FIGS. 9 and 10, since, in the shield casing 102, the ribs 78e and 78f are formed instead of the ribs 78b and 78c in the shield casing 56 according to the first embodiment, between the shield casing 102 and lower casing 48 with the rigid circuit board 54 interposed in-between, elements which cause impediments to the linear transmission of the press-down load or the impact load are eliminated, thereby being able to further suppress the occurrence of a shearing force and a bending moment in the rigid circuit board 54. This makes it possible to prevent the breakage of the circuit board, electronic components and the like.

By the way, in the above-mentioned first and second embodiments, the side wall 76 and the rib 78 of the shield casings 56 and 102 contact with the rigid circuit board 54 or semiconductor integrated circuits 62, 64, 66 and the like originally before the press-down load or impact load is applied. However, the side wall 76 and the rib 78 of the shield casings 56 and 102 may be formed such that they originally have a slight space with respect to the rigid circuit board 54 or semiconductor integrated circuits 62, 64, 66 and the like.

In this case, the side wall 76 and the rib 78 of the shield casings 56 and 102 are slightly bent when the press-down load or impact load is applied, and thereby contact with the rigid circuit board 54 or semiconductor integrated circuits 62, 64, 66 and the like. Therefore, similarly to the first and second embodiments, the press-down load or impact load is transmitted therethrough, so that similar operation effects similar to the first and second embodiments are provided.

Also, in the first and second embodiments, description is given of the cases in which the invention is applied to the folding-type portable telephones 30 and 100. However, the present invention can also be applied to portable terminal devices other than the folding-type portable telephones 30 and 100, such as a PHS (Personal Handy phone System), a PDA (Personal Digital Assistant), and a portable navigation device.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A portable terminal device, comprising:
a first casing member;
a second casing member facing the first casing member so as to form a box casing;
a board being placed between the first casing member and the second casing member;
a key component of which portions being exposed externally from key holes formed in the first casing member;
a first electronic component mounted on one surface of the board, said one surface facing the first casing member;
a shield member mounted on said one surface of the board so as to cover the first electronic component; and
at least one of a second electronic component and an electrical component mounted on other surface of the board, said other surface facing the second casing member,
wherein the shield member has at least one first supporting portion formed toward said one surface of the board at a position corresponding to an intermediate position of said one surface of the board, and
the second casing member has at least one second supporting portion formed toward said other surface of the board at a position corresponding to an intermediate position of said other surface of the board.

2. The portable terminal device as claimed in claim 1, wherein the first supporting portion touches said one surface of the board.

3. The portable terminal device as claimed in claim 2, wherein the shield member includes a conductive member,
the board has a reference potential pattern formed on said one surface, and
the first supporting portion touches the reference potential pattern.

4. The portable terminal device as claimed in claim 1, wherein the first supporting portion touches the first electronic component.

5. The portable terminal device as claimed in claim 4, wherein the first supporting portion touches a peripheral edge portion of the first electronic component.

6. The portable terminal device as claimed in claim 1, wherein the first supporting portion includes some rib that protrudes toward said one surface of the board.

7. The portable terminal device as claimed in claim 1, wherein the first supporting portion touches the board when at least one of the key component and the first casing member is pressed.

8. The portable terminal device as claimed in claim 1, wherein the second supporting portion touches said other surface of the board.

9. The portable terminal device as claimed in claim 1, wherein the second supporting portion touches said at least one of the second electronic component and the electrical component.

10. The portable terminal device as claimed in claim 9, wherein the second supporting portion touches a peripheral edge portion of said at least one of the second electronic component and the electrical component.

11. The portable terminal device as claimed in claim 1, wherein the second supporting portion includes some rib that protrudes toward said other surface of the board.

12. The portable terminal device as claimed in claim 1, wherein the first supporting portion and the second supporting portion are arranged so as to be opposed to each other in a direction in which the first casing member and the second casing member are facing each other.

13. The portable terminal device as claimed in claim 1, wherein the first electronic component is arranged on said one surface of the board in a position corresponding to said at least one of the second electronic component and the electrical component mounted on said other surface of the board,
the first supporting portion touches the first electronic component, and
the second supporting portion touches said at least one of the second electronic component and the electrical component being arranged in a position corresponding to the first electronic component.

14. The portable terminal device as claimed in claim 13, wherein a contact area of the board and said at least one of the second electronic component and the electrical component is larger than a contact area of the board and the first electronic component.

15. The portable terminal device as claimed in claim 1, wherein the second casing member has an opening portion at its side surface,
the electrical component is arranged so as to be adjacent to the opening portion of the second casing member, and
the first supporting portion touches the board in a position corresponding to the electrical component at a side opposite to the opening portion.

16. The portable terminal device as claimed in claim 1, wherein the key component is arranged on the shield member on a side of the first casing member.

17. A portable terminal device, comprising:
a first casing member;
a second casing member facing the first casing member so as to form a box casing;
a board being placed between the first casing member and the second casing member;
a key component of which portions being exposed externally from key holes formed in the first casing member;
a first electronic component mounted on one surface of the board, said one surface facing the first casing member;
a shield member mounted on said one surface of the board so as to cover the first electronic component; and
at least one of a second electronic component and an electrical component mounted on other surface of the board, said other surface facing the second casing member,
wherein the second casing member has a supporting portion for supporting the board against a pressing force being exerted when at least one of the key component and the first casing member is pressed, the supporting portion being formed at a position corresponding to an intermediate position of said other surface of the board.

18. A portable terminal device, comprising:
a first casing member;
a second casing member facing the first casing member so as to form a box casing;
a board being placed between the first casing member and the second casing member;
a key component of which portions being exposed externally from key holes formed in the first casing member;
a first electronic component mounted on one surface of the board, said one surface facing the first casing member;
a shield member mounted on said one surface of the board so as to cover the first electronic component; and
at least one of a second electronic component and an electrical component mounted on other surface of the board, said other surface facing the second casing member,
wherein a pressing force being exerted when at least one of the key component and the first casing member is pressed is supported by the second casing member through the board and at least one of the shield member, the first electronic component, the second electronic component and the electrical component.
